(19) United States
(12) Patent Application Publication
(10) Pub. No.: US 2014/0101995 A1
(43) Pub. Date: Apr. 17, 2014

(54) Plant Support and Stabilization System

(71) Applicant: Gilbert Hernandez, JR., Moreno Valley, CA (US)

(72) Inventor: Gilbert Hernandez, JR., Moreno Valley, CA (US)

(21) Appl. No.: 14/056,923

(22) Filed: Oct. 17, 2013

Related U.S. Application Data
(60) Provisional application No. 61/715,106, filed on Oct. 17, 2012.

(51) Int. Cl. A01G 9/12

(52) U.S. Cl. CPC A01G 9/122
USPC 47/44

(57) ABSTRACT

A plant support device is disclosed formed of malleable members such as wire. A base engages a central support structure in a vertical disposition to support a planar platform which may be angled. Plant stalks are protected by following a central pathway through the base and support structure. Leaves and branches of he plant are supported in an elevated position by the platform which may be angled to maximize light to the plant, or maintain separation from adjacent plants. The various components may be provided in a kit for assembly as needed by the user.

This application claims priority to U.S. Provisional Patent Application Ser. No. 61/715,106 filed on Oct. 17, 2012, and which is incorporated herein in its entirety by this reference thereto.

### BACKGROUND OF THE SYSTEM

1. Field of the Invention

The present invention relates generally to gardening. More particularly, the invention relates to plant support such as a trellis which is employable as individual components or in combinations of the components from a kit thereof. The device is configurable to provide a stabilizing structure having a pivotally engaged substantially planar platform, and a soil engageable base support structure to maintain the trellis stable and supported. The device is preferably formed from thin formable members such as wire or polymeric materials which may be formed during extrusion, or similar materials which form a serpentine unitary structure.

2. Prior Art

Gardening has been a hobby and lifestyle for many individuals for most all of recorded history. The gardener often achieves satisfaction from putting in hard work and obtaining a reward in the form of decorative plants or edible fruits and vegatables which far exceed those commercially available in stores.

In fact, growing vegetables and other plants for consumption is a significantly healthier alternative to store purchased produce which generally are provided by commercial growers using insecticides and fertilizers which can remain on the plants. Further, growing flowers and decorative plants, at home, yields a crop which need not be submitted to the rigors of transporting like commercially grown plants. Once harvested and placed inside living quarters, such plants can provide a means for beautification of ones garden and home.

Additionally, through selling items grown, growers can increase their income using their own land as a growing asset. Still further, growing decorative and edible plants for self consumption eliminates costly trips to the grocery store, thereby saving the user money in addition to the income from selling their crop.

In small yards of conventional household real estate, finding an area with the correct sun and water access to grow a variety of plants is a significant problem. Raised bed gardens are a common type of garden for individuals who have even small areas of real estate to accommodate a garden, such as in a moderately sized backyard. A raised bed garden can significantly increase the growing area available by using vertical space above the ground. Conventional raised gardens generally consists of a framed enclosure or structure, placed above ground, whereafter soil is placed therein in soil beds and above the existing soil. The plants grown in such raised beds are typically spaced in geometric patterns which allows the user to more densely grow the plants as compared to conventional row gardening.

For some vegetables such as tomatoes, and other climbing and vine like plants, trellises and wire cages are conventionally employed to support the weight of the plant during growth and especially before harvest. A simple trellis or elevated support structure can be built by employing a plurality of upright support posts around the plants and tying strings between the spans of the posts.

The trellises conventionally provide support by using a tying of the vines and stalks of the growing plants to the trellis. This is done by engagement either directly to the posts or to a span of string stretched between supports thereby allowing climbing plants to bind themselves to the structure. Cages can be very beneficial to crop outcome as they often encircle the entire plant. This surrounded engagement provides protection against inadvertently stepping on the plants, and prevents consumption from wild or domestic animals who may find a raised tomato patch too attractive to ignore.

However, a number of shortfalls with conventional raised plant support devices are well known. Firstly, for large or potentially large plants and vegetables, the formed trellis or cage conventionally must additionally be made quite large making it heavier and making it occupy more space. Great care must be taken to ensure the plant is correctly supported by the device as it continues to grow because being so large allows for large drops if displaced. Most such structures are fixed in size, heavy, and not adaptable in positioning or form, to adapt to growing plant shapes and positions.

For example, where using a trellis for plant support, the user will often be required to continually tie the tomato vine to the trellis as it grows longer and becomes fruit laden. This is required to insure the plant receives proper sunlight during vertical growth and can support the heavy fruit. If the user engages the plant to the trellis incorrectly, portions of the plant may sag or potentially die off which can also damage or kill the distal portions of the vine by removing their nutrient conduit. If the user employs wire or non elastic material to encircle the plant and support, and the diameter of the plant grows larger, the tie can cut the plant or severely limit fluid flow therethrough causing damage to or even death of the plant. Additionally, such ties generally require two hands and in awkward positionings that plants reach, securement is hard or almost impossible.

Further, as the plant grows ever larger, the trellis will often become unstable due to the weight of the plant and heavy fruit. Thus, the supporting trellis may possibly break under the weight of the growing plant. Still further, conventional wire cage and trellis configurations, while keeping wildlife at bay, tend to inhibit the user from hand and arm access the growing plants, such as is needed during cultivation or pruning.

Aside from outdoor raised bed gardens, many users who have limited space opt for indoor gardening. Methods of indoor gardening can include hydroponic and aeroponic systems, as well as soil gardening out of buckets or pots, to name a few. Despite the obvious downfall of limited space, indoor gardeners are often required to provide their own light source. Florescent and LED's are common light sources which can provide low cost and efficient growing performance. However, when growing many individual plants at the same time in a finite space, it is often difficult to ensure all plants receive adequate sunlight from the often limited light source. As a result, some plants in the many may thrive, while others die off quite easily or are stunted. Consequently, a means for directing the growth of plants towards the light source, or aligned with incoming light, without harming the plant, will substantially alleviate this problem.

As such, there is a continuing unmet need for an improved plant support and stabilizing system and method which solves many of the problems associated with conventional plant support devices and methods such as trellises. Such a device and system should be lightweight, configurable to an infinite number of supporting configurations, structurally strong and stable, yet lightweight. Such a device system should provide a user configurable means for supporting and stabilizing the vertical growth of the plant at one or a plurality of different points on the plant, easily and with minimal circumferential ties on the plant and support. Such a device should provide a user with means for directing the growth of the plant toward a light source or future lightsource to be installed, should the plant need better lighting, or increased lighting at differing periods prior to harvest or full growth.

The forgoing examples of related art, and shortcomings and limitation related therewith, are intended to be illustrative and not exclusive, and they do not imply any limitations on the system and method of the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the provision of a plant support and stabilizing device and method which allows the user to form and configure customized plant supports such as a trellis. In accordance with one preferred mode of the device and system, the various individual components of the kit of components of the device disclosed herein, are preferably formed as unitary structures of conventional formable or pliable materials such as bedable wire or tension wire of varying gauges which may be bent to form configurations allowing ground support as well as plant engagement and support using a serpentine configuration. However, the components of the device and system can be formed of any material suitable for the purposes set forth in this disclosure, such as polymeric materials which are pliable when heated and can be formed to the serpentine shapes like wire to provide the components herein. The components of the device employable with the system herein, preferably includes a stabilizing structure for the plant, and base support component holding the stabilizing structure elevated. The stabilizing structure may be employed with or separately from the base support as needed, or formed as a part thereof in a unitary structure of support and stabilizing structure.

The stabilizing structure includes an elongated pliable or formable member which when bent to form a shape, remains in the formed shape. Wire, or as noted formable members from polymeric or other plastic materials, may be employed to form the various shapes, such as member formed elevated frame, elevated or extending up from proximal leg portions, to a distal pivotally engaged grid forming a platform.

The platform is preferably substantially planar and formed substantially rectangular in shape and preferably centered around the frame. By substantially planar, it is meant that most or all of the platform is flat or within a few degrees of falling in the same plane. Substantially rectangular is of course having four sides, all or most of which have edges perpendicular or within a few degrees of such, relative to adjoining sides.

In use, the device provided by the components is positioned above or adjacent to a upper end of the growing plant such that the plant, as it grows upward, extends substantially centrally through a frame, and up towards the platform. As the plant grows vertically towards the platform from a root bed, its distal end begins to widen, as do the diameters of the vines communicating therewith. The branches or extending vines of the plant thereafter can be engaged to the platform therefor providing a means for supporting the plant in an elevated position and stabilizing the plant.

In addition, the platform in one particularly preferred mode of the device and system, may be pivoted, rotated or otherwise titled at angles from the underlying support. This provides the user a means for directing the subsequent growth of the plant toward one direction or the other as plants, especially vines, inherently will follow the slant of their support. This ability to angle the supported plant portions during growth and at maturity is especially beneficial for indoor growing with limited light source. By employing the means for angling the support structure of elevated portions of the plant, some plants in a field of indoor plants can be directed to grow, or be positioned, toward or in view of one light source to maximize light transmission. Others in a group of plants employing the system components can be directed to another positioned light source.

In other modes of the device and system, it is noted that the stabilizing structure may have additional tiers of platforms having grids, which extend vertically from the supporting frame, which will allow for support and stabilization of even taller plants.

In at least one preferred mode, the base support member is also formed of wire, or pliable material forming a member which remains substantially in a bent or formed shape. The support member is configured to stake into the ground or supporting soil and engage the legs of the stabilizing structure components, to support the legs in proper position to maintain the stabilizing structure properly oriented.

The base support may include a plurality of receiving apertures which can be employed as a means for registered engagement of the legs of the stabilizing structure. In addition, the formed apertures of the base provide a means for uniform construction of a plurality of the formed stabilizing structures, and a means to form a pattern for a plurality of plants prior to growth, should the user be growing many plants.

Due to the formation of the structure of a member that is formable to shape, such as a wire formed construction, it is additionally preferred that the base is formed from only a few individual members using lengths of, for instance, wire, configured to a unitary structure, to reduce manufacturing costs associated with welding or otherwise engaging such multiple length of wire to form the base structure.

In at least one preferred mode, the number of lengths of wire needed to form the base is two, which are bent into a serpentine like configuration to form the desired shape, and employs few if any welds to complete the structure. However, in at least one other mode, the base, and formed apertures, can be formed from plastic employing conventional forming techniques such as injection molding, or other suitable means.

In all preferred modes, the base component includes a central located passage with an open portion such as a substantially C-shaped passage. The passage allows for alignment centrally with the frame of the stabilizing structure during use, and communicates around the stalk of plant which is easily positioned therein through the gap formed in the passage. The C-shape allows the user to engage or remove the base from around the plant as needed without disturbing the plant, however the central passage may be other shapes, such as triangular, rectangular, or other shapes so long as the circumference defining the passage or aperture positions a gap to allow insertion of a plant therethrough.

In accordance with still yet another preferred mode of the device and system, the grid on the elevated platform is instead supported by a plurality of sidewalls. In use, the formed sidewalls will provide a barrier to protect the plant from domestic and wild animals who will be inhibited from eating the plant between the sidewalls. Further, the sidewalls define a barrier which separates one plant from another.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects, features, and advantages of the plant supporting device and system of the dicslosed invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a side view of a preferred mode of the stabilizing structure of the invention comprising a central frame extending from supporting a base support shown as leg portions having distal portions communicating in engagement with a gridded platform.

FIG. 2 shows a top view of the stabilizing structure of FIG. 1, showing the planar overhang and detailing the gridded platform.

FIG. 3 shows a side view of the stabilizing structure of FIG. 1 with the gridded platform tilted at an angle through a bending or pivoting engagement with leg portions.

FIG. 4 shows a top view of another preferred mode showing the base support component formed from two length of elongated member such as wire.

FIG. 5 shows a side view of the base component depicting the two lengths of wire in a serpentine configuration, each forming half of the base.

FIG. 6 shows the two halves of FIG. 5 engaged to form the base, which employs at most four points of connection such as welds or ties or the like, to complete the structure.

FIG. 7 is a top view of another particularly preferred mode of a base component which can be formed from plastic.

FIG. 8 shows a side view of the mode of the base component of FIG. 7 also showing preferred staking components which are employed to stake the base into the ground or soil through formed apertures in the base component.

FIG. 9 shows an example of a particularly preferred mode of the device such as in FIG. 1, in an as-used position, with angled support, employing the base component of FIG. 4 for supporting the stabilizing structure.

FIG. 10 shows an example of yet another mode of the device employing at least one additional planar parallel tier forming the gridded platform.

FIG. 11 shows a top view of still yet another mode of a base component with is adapted to engage onto the rim of a conventional bucket or pot having soil therein, for indoor soil growing.

FIG. 12 shows a side view of FIG. 11 showing pot rim engaging hooked portions.

FIG. 13 shows a perspective view of the base component of FIG. 11 in the as-used mode engaged to the rim of a bucket.

FIG. 14 shows still yet another particularly preferred mode of the invention wherein the gridded platform is supported by the rotatable engagement to a plurality of sidewalls.

### DETAILED DESCRIPTION OF THE PREFERRED EMBODIMENTS OF THE INVENTION

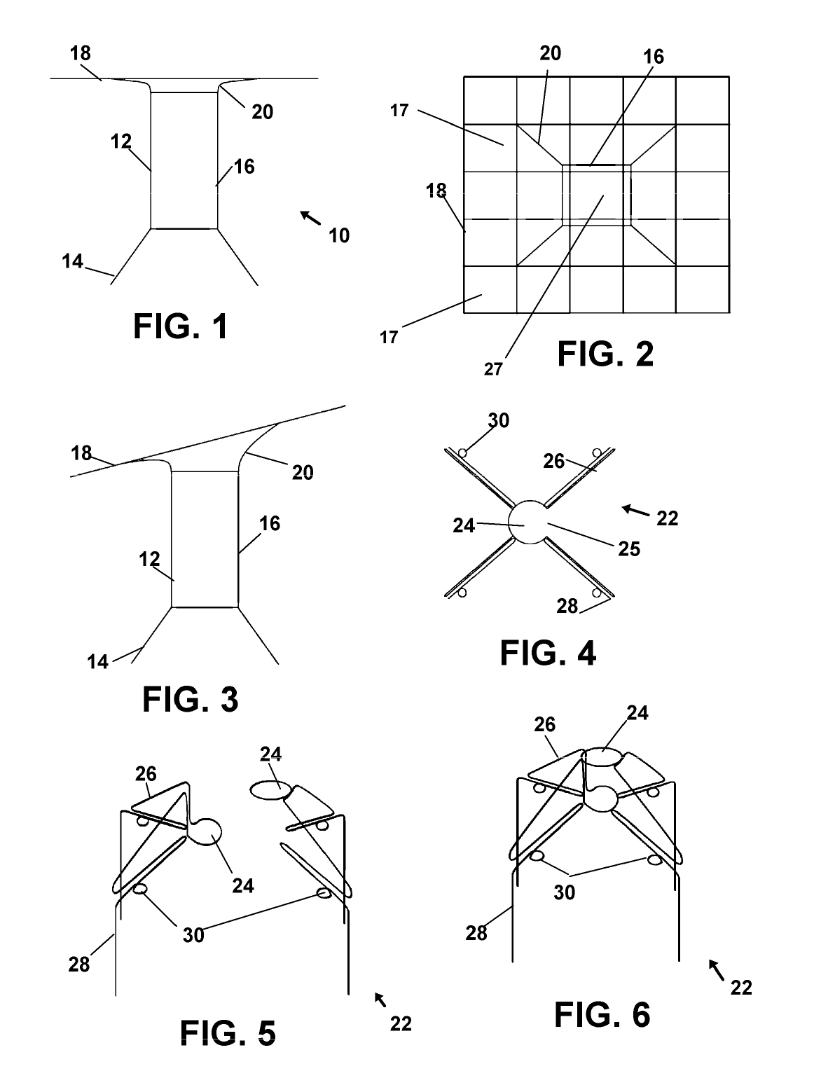

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Further, the components shown in FIGS. 1-14 may be included in a kit of a plurality of some or all respective components and thereby allowing the user to choose and combine respective individual components for engagement to each other to form the plant supporting structures herein and adapt the formed structures to the local indoor or outdoor growing area and light considerations.

Now referring to drawings in FIGS. 1-14, wherein similar components are identified by like reference numerals, there is seen in FIGS. 1, 2, and 3 views of a particularly preferred mode of the plant stabilizing structure 12 of the device 10 and system herein. The stabilizing structure 12 generally comprises an elongated frame 16 for supporting the platform 18 elevated. The stabilizing structure 12 may formed from a malleable yet sturdy member material such as metal wire, such as 9-gauge steel tension wire. Malleable wire works well to form the elongated lengths and serpentine shapes herein, however polymeric materials or plastic materials which can also be bent to form shapes, during heating or after cooling, may also be employed as might metal members formed in a planar or rectangular shape instead of round. Those skilled in the art will recognize various other materials which are suitable for bending to shape which they will maintain, to form the components in the kit or as individual items providing the plant supporting device 10, and are anticipated.

The support or stabilizing structure 12 additionally includes one or a plurality of engaged leg portions 14 engaged at a first end in a pivotal engagement by bending, or by hinged type connection, with the platform preferably having a grid construction of apertures surrounded by members from the platform 18. The opposite end of the leg portions 14 are adapted for engagement directly in the soil, or in another preferred mode of the device 10 into cooperative engagement with apertures in registered positions in a base 22 or the like.

The platform 18 has a grid like structure also preferably formed from wire. In use in FIG. 9, the platform 18 provides a support grid as a means for supporting, organizing, and stabilizing the branches or vines of a vertically growing plant 100 which have individual stalks which will communicate through the apertures in the grid, and thereby maintain a separated and orderly position for incoming light and separated from each other and adjacent plants.

Means for pivotal engagement of the platform 18, to the frame 16, is herein provide by one or a plurality of connecting wires 20 or members, communicating between the top of the frame 16 to connection points on the grid 18 within the perimeter edge of the platform 18. The connecting wires 20 are preferably malleable such that the user can tilt the platform 18 to a desired angle when in use, by simply bending the connecting wires 20 as needed. It is noted and anticipated that other means for pivoting engagement which one skilled in the art may recognize as suitable for the intended purpose may also be employed which will allow for a angled but fixed positioning of the platform 18. Therefor the means for angling the platform 18 of the device 10 should not be considered limited by the current depiction.

FIGS. 4, 5 and 6 show views of a first particularly preferred mode of a base 22 support component. In this mode, the base 22 is preferably formed from malleable wire or malleable member-like material capable of holding a bent or formed shape. With wire, at most two lengths of wire are bent into serpentine configurations to form two halves of the base 22, as shown in FIG. 5 having a plurality for formed apertures 30 in registered engagements to engage with legs 28 once engaged with soil.

As shown in FIG. 4, base 22 also preferably includes a centrally located passage 24 having a gap 25 in the perimeter of the circumference defining the passage 24, which allows means for ingress and egress and thus engagement and disengagement of the the base 22 around the plant 100 without disturbing the plant 100. This also allows for subsequent moving of the plant in or out of the passage 24 as needed. A C-shaped passage perimeter defining the passage 24 is shown as the circular shape provides a strong center, however other shapes may be employed so long as they have a gap 25 to insertion and removal of plant stalks therethrough.

Also in FIG. 4 arm portions 26 extend radially from engagements on the metal perimeter component defining from the central passage 24, to vertically disposed legs 28 which maintain the central passage 26 centrally located between the plurality of radially positioned legs 28. The legs 28 are employed for staking or inserting into ground positioning the base 22 and central passage 26 adjacent thereto or slightly elevated therefrom.

Further shown in the current configuration are the two piece base component 22 of FIGS. 5-6, adapted for employment for connections such as welds, or zip ties, or the like, to engage the halves and form the base component 22 in FIG. 6. This will allow manufacturing costs to be substantially reduced through the employment of mirrored positioning of a single manufactured component formed in unitary structures of wire bent in a serpentine fashion. A plurality of apertures 30 provided by forming loops in the wire provide means for registering the engagement of the stabilizing structure 12 to the base 22 in the as used mode of FIG. 9.

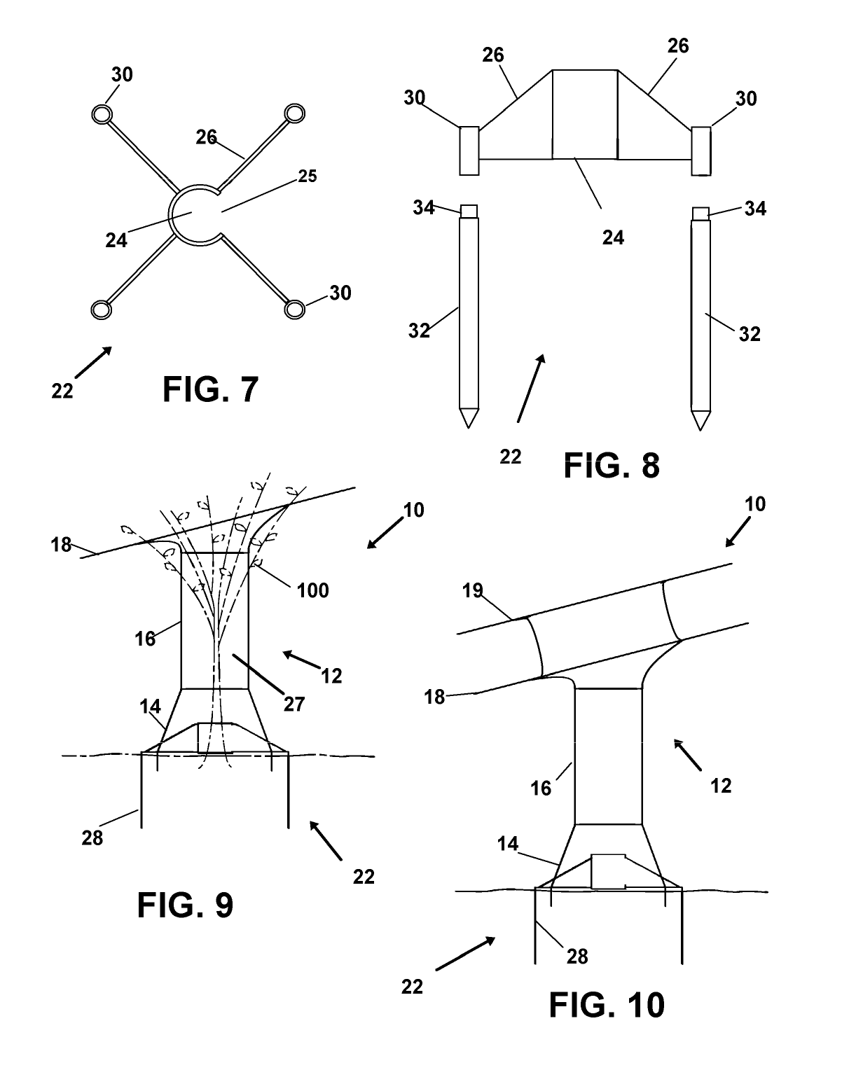

FIGS. 7 and 8 show an additional preferred mode of the base 22 component which can be formed from metal or plastic or other suitable material to maintain the apertures 30 in registered positions to receive engagement. As can be seen, the registered apertures 30 are provided by apertures formed in the bent cylindrical members which are engaged at their perimeters to the distal ends of the arm portions 26. Further, the C-shaped passage 24 can also be formed by a cylindrical body such as pipe, having an axial passage 24 and a portion of sidewall cut out to form the gap 25 and the shown C-shape. In this mode, staking components 32 include end positioned engagement collars 34 which can be engaged into the axial passage of the underside of the apertures 30 and therefor provide a means for removable engagement thereof from the driven staking components 32. The staking components 32 can additionally be formed from plastic, metal, or any other suitable material.

FIGS. 9 and 10 show examples of particularly preferred as-used modes of the device 10 having the stabilizing structure 12 engaged elevated above the base component 22. As can be seen a plant 100 is positioned in communication through a central channel 27 communicating through the base 22, and frame 16, such that the plant 100 will grow substantially centrally up through frame 16 and then have one or more branches communicate through apertures 17 in the grid provided by the platform 18. This central channel 27 provides protection from animals who cannot get to the plant 100 surrounded by the wires or members forming the passage 24. If desired, the user can then secure vines or multiple branches of the plant 100 to the platform 18 with string or other ties, or if the plant 100 gripping tendrils, will engage the wires forming the apertures 17 in the platform 18 during growth such may not be needed. FIG. 10 shows another mode of the device 10 wherein an additional parallel and separated planar tier is provided engaged by members therebetween and forming at least one additional platform 19 extending therefrom.

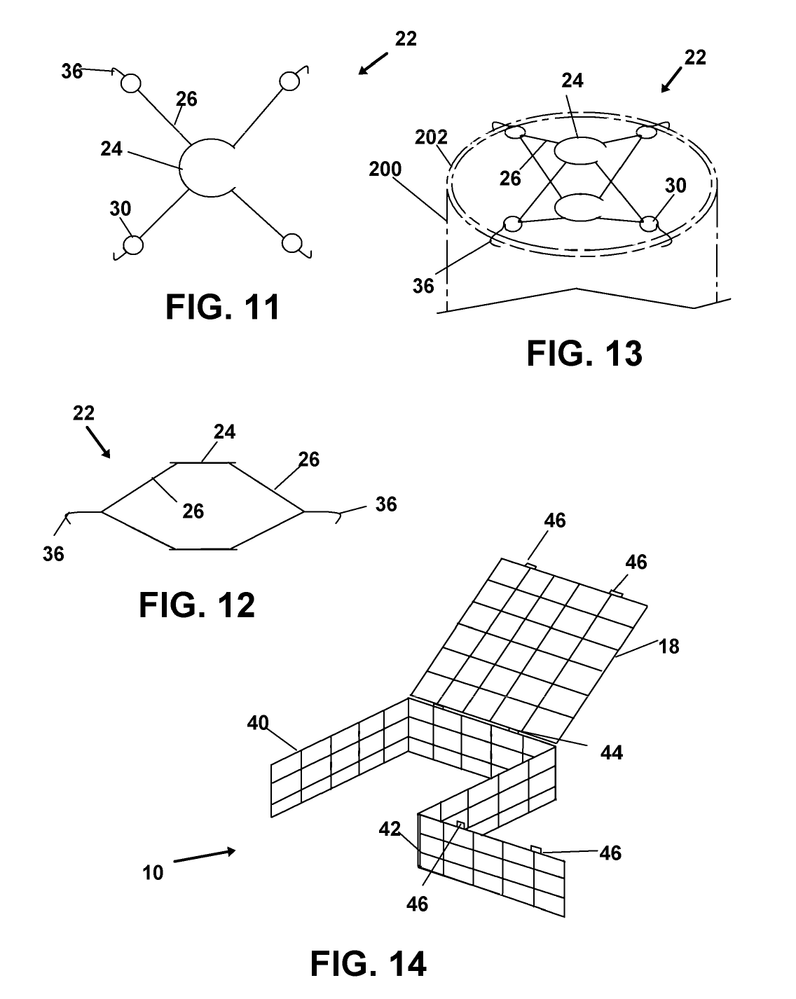

FIG. 11-13 show still yet another preferred mode of the base component 22 which is adapted for engagement around the rim 202 of a bucket 200, or pot, which are conventionally employed for indoor soil gardening. As can be seen, the distal ends of the arm portions 26 include hooks 36 providing a means for engaging the rim 202 as shown in FIG. 13 and not sliding therefrom. Although not currently shown, the stabilizer structure 12 can be engaged over the base 22 through the registered engagement with the apertures 30.

FIG. 14 is yet another particularly preferred mode of the invention wherein the gridded platform 18 is supported by one or a plurality of sidewalls 40 which form a type of enclosure. Preferably, at least one of the sidewalls 40 is rotatably engaged 42 such that the sidewall 40 is openable as a door. The platform 18 is preferably hinged 44 to a top edge of one of the sidewalls 40. Complimentary removable fasteners 46 are employed to lock the platform 18 over the sidewalls 40 if needed.

This invention has other applications, potentially, and one skilled in the art could discover these. The explication of the features of this invention does not limit the claims of this application; other applications developed by those skilled in the art will be included in this invention.

It is additionally noted and anticipated that although the device is shown in its most simple form, various components and aspects of the device may be differently shaped or slightly modified when forming the invention herein. As such, those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, and various changes and substitutions, are intended in the foregoing disclosure and it will be apparent that, in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A plant support apparatus, comprising:
a substantially planar platform having a first side opposite a second side and having a circumference defining a shape;
a plurality of apertures communicating between said first side and said second side of said platform;
a frame having a first end in an engagement with said platform;
said frame having a plurality of leg portions extending from a second end, opposite said first end;
said leg portions insertable into soil or other growing medium, to thereby position said frame in an upright position;
said frame in said upright supporting said platform in an elevated position above said soil;
a pathway extending centrally through said frame and at least one of said apertures in said platform, said pathway defining a surrounded path for said plant to grow, said pathway extending between a first end adjacent said soil to said aperture in said platform, whereby a plant growing in said soil may have a central portion thereof extending from roots in said soil, along said pathway and project distal end portions of said plant therefrom, above said first side surface of said platform.

2. The plant support apparatus of claim 1, additionally comprising:
said frame having a circumferential wall defining a perimeter of said pathway;
said wall of said frame providing means for preventing animals from contact with said central portion of a said plant grown in combination herewith and a consuming thereof.

3. The plant support apparatus of claim 1, additionally comprising:
a plurality of said apertures in said platform communicating with said pathway;
each of said plurality of apertures defining respective separate exit apertures for respective distal ends of said plant therethrough; and
said apertures thereby forming a separation between said distal ends projecting above said first side of said platform.

4. The plant support apparatus of claim 1, additionally comprising:
said engagement of said platform with said first end of said frame, configured to pivot said frame to position said first side of said platform to a plurality of differing angles between a horizontal positioning to a vertical positioning, whereby said platform can be adjusted by a user to position said distal ends of said plant to positions adapted to optimize light received by said distal ends of said plant.

5. The plant support apparatus of claim 2, additionally comprising:
said engagement of said platform with said first end of said frame, configured to pivot said frame to position said first side of said platform to a plurality of differing angles between a horizontal positioning to a vertical positioning, whereby said platform can be adjusted by a user to position said distal ends of said plant to positions adapted to optimize light received by said distal ends of said plant.

6. The plant support apparatus of claim 3, additionally comprising:
said engagement of said platform with said first end of said frame, configured to pivot said frame to position said first side of said platform to a plurality of differing angles between a horizontal positioning to a vertical positioning, whereby said platform can be adjusted by a user to position said distal ends of said plant to positions adapted to optimize light received by said distal ends of said plant.

7. The plant support apparatus of claim 1, additionally comprising:
a base, said base configured for a staked engagement with said soil and having an opening positioned therein communicating between said soil and said pathway; and
apertures formed in said base in positions complimentary to positions of said leg portions whereby said leg portions engage with said apertures.

8. The plant support apparatus of claim 2, additionally comprising:
a base, said base configured for a staked engagement with said soil and having an opening positioned therein communicating between said soil and said pathway; and
apertures formed in said base in positions complimentary to positions of said leg portions whereby said leg portions engage with said apertures.

9. The plant support apparatus of claim 3, additionally comprising:
a base, said base configured for a staked engagement with said soil and having an opening positioned therein communicating between said soil and said pathway; and
apertures formed in said base in positions complimentary to positions of said leg portions whereby said leg portions engage with said apertures.

10. The plant support apparatus of claim 4, additionally comprising:
a base, said base configured for a staked engagement with said soil and having an opening positioned therein communicating between said soil and said pathway; and
apertures formed in said base in positions complimentary to positions of said leg portions whereby said leg portions engage with said apertures.

11. The plant support apparatus of claim 5, additionally comprising:
a base, said base configured for a staked engagement with said soil and having an opening positioned therein communicating between said soil and said pathway; and
apertures formed in said base in positions complimentary to positions of said leg portions whereby said leg portions engage with said apertures.

12. The plant support apparatus of claim 6, additionally comprising:
a base, said base configured for a staked engagement with said soil and having an opening positioned therein communicating between said soil and said pathway; and
apertures formed in said base in positions complimentary to positions of said leg portions whereby said leg portions engage with said apertures.

13. The plant support apparatus of claim 7, additionally comprising:
a gap formed in a perimeter of a wall defining said opening, said gap defining an access through said wall for a positioning of said plant, within said opening.

14. The plant support apparatus of claim 8, additionally comprising:
a gap formed in a perimeter of a wall defining said opening, said gap defining an access through said wall for a positioning of said plant, within said opening.

15. The plant support apparatus of claim 9, additionally comprising:
a gap formed in a perimeter of a wall defining said opening, said gap defining an access through said wall for a positioning of said plant, within said opening.

16. The plant support apparatus of claim 10, additionally comprising:
a gap formed in a perimeter of a wall defining said opening, said gap defining an access through said wall for a positioning of said plant, within said opening.

17. The plant support apparatus of claim 11, additionally comprising:
a gap formed in a perimeter of a wall defining said opening, said gap defining an access through said wall for a positioning of said plant, within said opening.

18. The plant support apparatus of claim 12, additionally comprising:
a gap formed in a perimeter of a wall defining said opening, said gap defining an access through said wall for a positioning of said plant, within said opening.
